(19) United States
(12) Patent Application Publication
(10) Pub. No.: US 2010/0196549 A1
(43) Pub. Date: Aug. 5, 2010

(54) MICROENCAPSULATED CITRUS PHYTOCHEMICALS AND APPLICATION TO SPORTS DRINKS

(75) Inventors: Teodoro Rivera, Algonquin, IL (US); Jeremy Crouse, Cary, IL (US); Peter S. Given, JR., Ridgefield, CT (US)

Correspondence Address: BANNER & WITCOFF, LTD.;and ATTORNEYS FOR CLIENT NO. 006943, 10 SOUTH WACKER DR., SUITE 3000, CHICAGO, IL, 60606, US

(73) Assignee: Tropicana Products, Inc., Bradenton, FL (US)

(21) Appl. No.: 12/364,853

(22) Filed: Feb. 3, 2009

(51) Int. Cl. A23L 2/52

(52) U.S. Cl. 426/89; 426/103; 426/519

(57) ABSTRACT

Methods are disclosed for fortifying a sports drink with one or more citrus phytochemicals while concealing the bitter taste of these compounds in the beverage. These methods comprise microencapsulating the citrus phytochemicals and adding the microencapsulated citrus phytochemicals to the beverage. Also disclosed are sports drinks fortified with one or more microencapsulated citrus phytochemicals but which do not have the bitter taste characteristics of these compounds.

### TECHNICAL FIELD

The present invention relates to beverages and methods for making beverages. In particular, this invention relates to beverages such as sports drinks fortified with citrus phytochemicals which have been microencapsulated to conceal their bitter taste.

### BACKGROUND

Consumer demand is increasing for food and beverage products fortified with functional ingredients that provide health benefits. Phytochemicals derived from fruits, vegetables, and other plants are currently being researched for their potential medicinal and general health-promoting properties. For example, flavonoids and limonoids are reported to provide health benefits. Citrus phytochemicals derived from citrus fruits are also of interest for their growing list of health benefits. However, beverages for health-conscious, physically active consumers, for example, sports drinks and isotonic beverages, have not been fortified with citrus phytochemicals (e.g., citrus flavonoids and citrus limonoids) largely because some of these compounds would impart bitterness at elevated concentrations, and so would provide an unpleasant taste experience.

It is therefore an object of the present invention to provide a method for fortifying a beverage (e.g., a sports drink, an isotonic beverage) with one or more citrus phytochemicals while concealing the bitter taste of these compounds in the beverage. It is also an object of the present invention to provide beverages (e.g., sports drinks, isotonic beverages) fortified with one or more citrus phytochemicals but which do not have the bitter taste characteristics of these compounds. These and other objects, features, and advantages of the invention or certain embodiments of the invention will be apparent to those skilled in the art from the following disclosure and description of exemplary embodiments.

### SUMMARY

In accordance with a first aspect of the invention, a beverage is provided which comprises water, at least one hydration improving substance, and at least one microencapsulated citrus phytochemical composition comprising a citrus phytochemical which contributes at least 60% by weight (e.g., at least 80% by weight, at least 95% by weight) of the total amount of citrus phytochemical in the microencapsulated citrus phytochemical composition. In certain exemplary embodiments, the hydration improving substance comprises at least one of an electrolyte, a carbohydrate, a betaine, and glycerol. In certain exemplary embodiments, the beverage is at least one of a sports drink, an isotonic beverage, a hypertonic beverage, and a hypotonic beverage. In certain exemplary embodiments, the microencapsulated citrus phytochemical composition comprises at least one of a citrus flavonoid and a citrus limonoid, and optionally comprises a tocopherol. In certain exemplary embodiments, the citrus flavonoid comprises at least one of hesperidin, hesperetin, neohesperidin, naringin, naringenin, quercetin, quercitrin, rutin, tangeritin, narirutin, nobiletin, poncirin, scutellarein, and sinensetin. In certain exemplary embodiments, the citrus limonoid comprises at least one of limonin, obacunone, nomilin, and glucosides of any of them.

In accordance with a second aspect of the invention, a beverage concentrate is provided which comprises at least one hydration improving substance and at least one microencapsulated citrus phytochemical composition comprising a citrus phytochemical which contributes at least 60% by weight (e.g., at least 80% by weight, at least 95% by weight) of the total amount of citrus phytochemical in the microencapsulated citrus phytochemical composition. When the beverage concentrate is diluted with water, it produces a beverage which is a sports drink.

In accordance with another aspect, a method is provided for preparing a beverage comprising the steps of providing at least one citrus phytochemical composition comprising a citrus phytochemical which contributes at least 60% by weight (e.g., at least 80% by weight, at least 95% by weight) of the total amount of citrus phytochemical in the citrus phytochemical composition, microencapsulating the citrus phytochemical composition, and mixing the microencapsulated citrus phytochemical composition with at least one hydration improving substance, water, and optionally at least one additional beverage ingredient. In certain exemplary embodiments, the step of microencapsulating the citrus phytochemical comprises at least one of core-shell encapsulation, complex coacervation, liposome formation, double encapsulations, spray-drying, and centrifugal extrusion.

In accordance with another aspect, a method is provided for preparing a beverage comprising the steps of providing at least one microencapsulated citrus phytochemical composition comprising a citrus phytochemical which contributes at least 60% by weight (e.g., at least 80% by weight, at least 95% by weight) of the total amount of citrus phytochemical in the citrus phytochemical composition, and mixing the microencapsulated citrus phytochemical composition with at least one hydration improving substance, water, and optionally at least one additional beverage ingredient.

### DETAILED DESCRIPTION

Sports drinks as disclosed herein include beverages which are consumed before, during, or after exercise or vigorous physical activity to rehydrate the consumer. Thus, sports drinks are also known as rehydration beverages. Sports drinks that replenish water and electrolytes lost through sweating, and sports drinks that provide carbohydrates to replenish energy are well known (see for example U.S. Pat. No. 5,780,094). Sports drinks can be hypertonic, isotonic, or hypotonic, with most sports drinks being moderately hypertonic. Isotonic beverages are aqueous solutions having the same or nearly the same osmotic pressure or concentration of any, some, or all membrane-impermeable solutes as found in the cells and/or blood of the human body. Hypertonic beverages have a greater concentration of such solutes, and so exert a greater osmotic pressure than that inside a cell. Hypotonic beverages have a lesser concentration of such solutes, and so exert a lesser osmotic pressure than that inside a cell. In certain exemplary embodiments, a beverage according to the present invention is at least one of a sports drink, an isotonic beverage, a hypertonic beverage, and a hypotonic beverage. In certain exemplary embodiments, beverages of the present invention are formulated to have an osmolality, when initially formulated, in the range of from about 220 to about 350 mOsm/Kg of the beverage (e.g., from about 230 to about 320, from about 250 to about 270 mOsm/Kg of the beverage). Beverages according to the present invention may rehydrate by replacing fluids, electrolytes, and/or energy lost through exercise, and may also assist in fluid absorption and/or fluid retention.

Beverages and beverage concentrates according to the present invention comprise at least one hydration improving substance. The hydration improving substance assists in fluid absorption and/or fluid retention by the body. In certain exemplary embodiments, the hydration improving substance comprises one or more electrolytes, carbohydrates, betaines, glycerol, or a combination of any of them. In certain exemplary embodiments, the hydration improving substance comprises at least one electrolyte and at least one carbohydrate.

In certain exemplary embodiments, the hydration improving substance comprises one or more electrolytes. In certain exemplary embodiments, the electrolyte comprises sodium, potassium, magnesium, calcium, chloride, or a mixture of any of them. As used herein, electrolytes are in ionic form, often as dissolved inorganic salts. It is believed that electrolytes play an important role in rehydration by affecting fluid replacement and fluid retention. In response to fluid loss during dehydration, water is distributed between fluid compartments so that both the extracellular and intracellular compartments share the water deficit. Sodium, potassium, magnesium, calcium and chloride are some of the more important electrolytes involved in filling these body fluid compartments. Beverages providing sodium and chloride encourage the filling of the extracellular compartment, while beverages providing potassium, magnesium, and calcium favor the filling of the intracellular compartment. Properly balancing the sodium, potassium, magnesium, calcium and chloride levels will further improve the rehydration properties of the beverage. These electrolyte ions assist in filling these body fluid compartments more rapidly and help to retain the fluid instead of it being excreted as urine.

Any source of sodium known to be useful to those skilled in the art can be used in the present invention. Examples of useful sodium sources include, but are not limited to, sodium chloride, sodium citrate, sodium bicarbonate, sodium lactate, sodium pyruvate, sodium acetate and mixtures thereof. When included in certain exemplary embodiments of the present invention, the sodium content of the beverage comprises at least about 30 mEq/L, preferably from about 30 to about 100 mEq/L of beverage, more preferably from about 30 to about 60 mEq/L of beverage, even more preferably from about 33 to about 40 mEq/L.

The chloride ion can come from various sources known to those skilled in the art. Examples of chloride sources include, but are not limited to, sodium chloride, potassium chloride, magnesium chloride and mixtures thereof. When included in certain exemplary embodiments of the present invention, the concentration of chloride is at least about 10 mEq/L, preferably from about 10 to about 20 mEq/L, more preferably from about 11 to about 18 mEq/L.

The potassium ion source can come from many sources known to those skilled in the art as being useful in the present invention. Examples of potassium sources useful herein include, but are not limited to, potassium monophosphate, potassium diphosphate, potassium chloride, and mixtures thereof. When included in certain exemplary embodiments of the present invention, the potassium content is at least 8 mEq/L, preferably from about 8 to about 20, and more preferably at from about 10 to about 19 mEq/L.

The magnesium ion can also come from many sources known to those skilled in the art. Examples of magnesium sources include, but are not limited to, magnesium oxide, magnesium acetate, magnesium chloride, magnesium carbonate, magnesium diphosphate, magnesium triphosphate, magnesium in the form of an amino acid and mixtures thereof. When included in certain exemplary embodiments of the present invention, the concentration of magnesium is at a level of at least 0.1 mEq/L, preferably from about 0.5 to about 6 mEq/L, more preferably from 1 to 3 mEq/L.

The calcium ion may come from a variety of sources known to those skilled in the art. Examples include but are not limited to, calcium lactate, calcium carbonate, calcium chloride, calcium phosphate salts, calcium citrate and mixtures thereof, with calcium lactate being preferred. When included in certain exemplary embodiments of the present invention, calcium is present at a concentration of at least 0.1 mEq/L, preferably from about 0.5 to about 6 mEq/L, more preferably from 1 to 3 mEq/L. Combinations of any of the disclosed electrolytes are also contemplated.

In certain exemplary embodiments, the hydration improving substance comprises one or more carbohydrates. In certain exemplary embodiments, the carbohydrate comprises sucrose, maltose, maltodextrin, glucose, galactose, trehalose, fructose, fructo-oligosaccharides, beta-glucan, trioses such as pyruvate and lactate, or a mixture of any of them. Carbohydrates provide sweetness, are a source of added energy, and may also facilitate uptake of electrolytes and water by cells. Certain exemplary embodiments of the beverage of the present invention include at least one carbohydrate in the range from about 4% to about 10% by weight of the beverage (e.g., from about 5.5% to about 6.5%, about 6% by weight of the beverage). In certain exemplary embodiments, combinations of carbohydrates comprises sucrose from about 1% to about 5% by weight of the beverage, glucose from about 1% to about 2.5% by weight, and fructose from about 0.8% to about 1.8% by weight, to produce a total carbohydrate content of 6% by weight of the beverage. More preferably, an exemplary combination of carbohydrates comprises sucrose from about 2% to about 4% by weight of the beverage, glucose from about 1.4% to about 2% by weight, and fructose from about 1.1% to about 1.5% by weight, to produce a total carbohydrate content of 6% by weight of the beverage.

In certain exemplary embodiments, the hydration improving substance comprises a betaine. A betaine is a net neutral chemical compound having a positively charged functional group which bears no hydrogen atom (e.g., ammonium or phosphonium), and a negatively charged functional group (e.g., carboxylate) which may not be adjacent to the positively charged functional group. Many betaines are osmolytes, substances synthesized or taken up from the environment by cells for protection against osmotic stress, drought, high salinity or high temperature. Intracellular accumulation of betaines, non-perturbing to enzyme function, protein structure and membrane integrity, permits water retention in cells, thus protecting from the effects of dehydration. In certain exemplary embodiments, the betaine comprises trimethylglycine.

In certain exemplary embodiments, the hydration improving substance comprises glycerol. As used herein, the term glycerol refers to glycerol itself and any ester, analog, or derivative which has the same function as glycerol in the composition described here. Glycerol induces a hyperosmotic effect, and causes water retention. Certain exemplary embodiments of the beverage of the present invention include glycerol in a concentration of from about 0.5% to about 5.0% by weight of the beverage (e.g., about 1.0% to about 3.0%)

Flavonoids are members of a class of polyphenols commonly found in fruits, vegetables, tea, wine, and dark chocolate. Flavonoids typically are categorized according to their chemical structure into the following subgroups: flavones, isoflavones, flavan-3-ols (otherwise known as flavanols), and anthocyanidins. Citrus fruits are an especially rich source of flavonoids, particularly flavones. Examples of flavones derived from citrus fruits include, but are not limited to, hesperetin, hesperidin, neohesperidin, quercetin, quercitrin, rutin, tangeritin, nobiletin, narirutin, naringin, naringenin, poncirin, sculellarein, and sinensetin. Flavones are characterized by a backbone structure (polyphenolic hydroxyl substitutents not shown) according to Formula I, having a phenyl group at the 2-position a carbonyl at the 4-position, and optionally a hydroxyl, ether, or ester substituent at the 3 position.

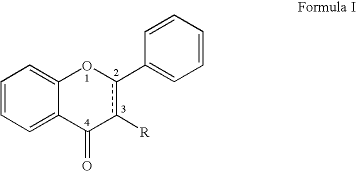

Limonoids are a class of triterpenes most commonly found in plants of the Rutaceae and Meliaceae families, particularly in citrus fruits and the neem tree. Examples of citrus limonoids include, but are not limited to, limonin, obacunone, nomilin, deacetylnomilin, and glycoside derivatives of any of them. Limonoids consist of variations on a furanolactone polycyclic core structure, having four fused six-membered rings with a furan ring. The structure of limonin, an exemplary citrus limonoid, is shown below as Formula II.

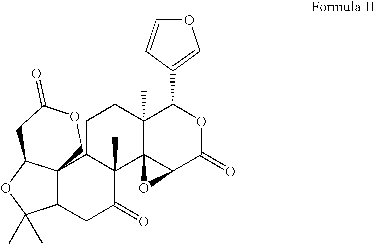

The present invention relates generally to fortification of beverages with citrus phytochemicals, wherein the bitter taste of most or all of the citrus phytochemicals has been concealed by microencapsulation. As used herein, a “citrus phytochemical” is any chemical compound derived from citrus fruit that may provide potential health benefits when consumed by or administered to humans. Citrus phytochemicals “derived” from citrus fruit include phytochemicals extracted or purified from one or more citrus fruits, synthetically produced phytochemicals having the same structural formulae as those naturally found in citrus fruits, and derivatives thereof (e.g., glycosides, aglycones, and any other chemically modified structural variants thereof). In certain exemplary embodiments, citrus phytochemicals include, but are not limited to, citrus flavonoids and citrus limonoids, and may be derived from citrus fruits, for example, orange, mandarin orange, blood orange, tangerine, clementine, grapefruit, lemon, rough lemon, lime, leech lime, tangelo, pomelo, pummelo, or any other citrus fruit. The terms “citrus flavonoid” and “citrus limonoid” as used herein comprise flavonoids and limonoids derived from citrus fruits, including flavonoids and limonoids extracted or purified from citrus fruit, synthetically produced flavonoids and limonoids having the same structural formulae as those naturally found in citrus fruits, and derivatives thereof (e.g., glycosides, aglycones, and any other chemically modified structural variants thereof). Citrus flavonoids include, but are not limited to, hesperidin, hesperetin, neohesperidin, naringin, naringenin, narirutin, nobiletin, quercetin, quercitrin, rutin, tangeritin, poncirin, scutellarein, and sinensetin. Citrus limonoids include, but are not limited to, limonin, obacunone, nomilin, deacetylnomilin, and glycosides of any of them.

According to the present invention, the bitter taste of citrus phytochemicals is concealed by microencapsulation. Microencapsulation sequesters the citrus phytochemicals and prevents them from interacting with taste receptors in the mouth and tongue. The citrus phytochemicals are substantially not released from microencapsulation in the mouth, but are released further down the gastrointestinal tract, for example, in the small intestine. Thus, when a beverage fortified with microencapsulated citrus phytochemicals is consumed, the consumer receives the health benefits of citrus phytochemicals without having to endure the bitter taste of these compounds. Microencapsulation of citrus phytochemicals provides the additional advantages of protecting the citrus phytochemicals from oxidation, heat damage, light damage, and other forms of degradation during processing and storage. Furthermore, a beverage comprising at least one microencapsulated citrus phytochemical may provide greater bioavailablity of the (microencapsulated) citrus phytochemical than an equivalent beverage comprising the same amount of that citrus phytochemical unencapsulated. Amounts of microencapsulated citrus phytochemical disclosed herein refer to the amount of citrus phytochemical and do not include the amount of encapsulant. “The same amount of that citrus phytochemical unencapsulated” includes the amount of microencapsulated citrus phytochemical minus the amount of encapsulant, and also includes any unencapsulated citrus phytochemical that may be present in the beverage comprising at least one microencapsulated citrus phytochemical. Microencapsulation protects the citrus phytochemical to a degree from degradation in the upper gastrointestinal tract, e.g., the mouth and the stomach, and so allows a larger amount of citrus phytochemical to pass into the intestines and be absorbed by the body.

In certain exemplary embodiments, the microencapsulated citrus phytochemical comprises at least one of a citrus flavonoid and a citrus limonoid. In those exemplary embodiments having more than one microencapsulated citrus phytochemical, for example, more than one citrus flavonoid, more than one citrus limonoid, or a combination of a citrus flavonoid and a citrus limonoid, each citrus phytochemical may be microencapsulated separately in separate particles, or the multiple citrus phytochemicals may be mixed together and microencapsulated together in the same particle. For example, a citrus flavonoid and a citrus limonoid may be microencapsulated separately in separate particles, or a citrus flavonoid and a citrus limonoid may be mixed together and microencapsulated in the same particle. In another example, where multiple citrus flavonoids are included, each citrus flavonoid may be separately microencapsulated in separate particles, or the multiple citrus flavonoids may be mixed together and microencapsulated in the same particle. In another example, where multiple citrus limonoids are included, each citrus limonoid may be separately microencapsulated in separate particles, or the multiple citrus limonoids may be mixed together and microencapsulated in the same particle. In certain exemplary embodiments, the microencapsulated citrus phytochemical composition comprises one or more of other functional ingredients, weighting agents, carriers, emulsifiers, and preservatives. Certain exemplary embodiments comprise at least one citrus flavonoid and a tocopherol microencapsulated in the same particle, or at least one citrus limonoid and a tocopherol microencapsulated together, a citrus flavonoid and a tocopherol microencapsulated together, or a combination of a citrus flavonoid, a citrus limonoid, and a tocopherol microencapsulated together. Tocopherols are forms of Vitamin E, occurring as alpha-, beta-, gamma-, and delta-tocopherol, determined by the number and position of methyl groups on the aromatic ring. Tocopherols provide health benefits as antioxidants, and when included in the microencapsulated citrus phytochemical, may also prevent oxidative degradation of the citrus phytochemical. In certain exemplary embodiments, the microencapsulated citrus phytochemical comprises a tocopherol in an amount of about 0.01 wt. % to about 1.0 wt. % of the total weight of the microencapsulated citrus phytochemical (e.g., 0.05 wt. % to 0.5 wt. %, about 0.1 wt. %).

As used herein, the term “microencapsulated citrus phytochemical” includes core-shell encapsulation, comprising particles having a core comprising one or more citrus phytochemicals and a shell of encapsulant material. Core-shell encapsulation may also include particles having multiple cores and/or multiple shells and/or agglomerated core-shell particles. Core-shell encapsulation can be produced by a variety of means including, for example, coacervation, centrifugal extrusion, solvent evaporation, spinning disk, electro-hydrodynamic spraying, spray drying, fluidized bed coating, etc. As used herein, the term “microencapsulated citrus phytochemical” may also include citrus phytochemicals microencapsulated in coacervates (e.g., complex coacervates), liposomes (e.g., lecithin encapsulant), nano-porous structures (e.g., cellulose particles, silica particles, kaolin, cyclodextrins), liquid crystalline structures (e.g., phospholipids, monoglycerides), natural encapsulants (e.g., yeast, fungal spores, pollen), or inclusion particles (e.g., particles of gelling polymer).

As used herein, the term “microencapsulated citrus phytochemical” includes particles having an average particle size in the micron/micrometer/μm range. In certain exemplary embodiments, microencapsulated citrus phytochemicals have an average particle size in the range of about 1 to about 500 microns (e.g., 5 to 300 microns, 10 to 200 microns, 20 to 150 microns, 50 to 100 microns, 10 to 50 microns). In certain exemplary embodiments, microencapsulated citrus phytochemicals have an average particle size in the range of about 0.05 microns to 20 microns (e.g., 0.1 to 10 microns, 0.5 to 2.0 microns). In certain exemplary embodiments, microencapsulated citrus phytochemicals have an average particle size of less than 1.0 micron (e.g., 0.05 to 0.9 microns, 0.1 to 0.5 microns). In view of this disclosure, the skilled artisan will be able to vary the particle size as necessary to be optimally included in a particular beverage product. Particle size may be selected based on the desired mouthfeel, visual appearance (e.g., clear, hazy, cloudy, or opaque), oxidation stability, and suspension stability within the beverage.

In certain exemplary embodiments, the microencapsulated citrus phytochemical comprises an encapsulant comprising at least one of a protein and a polysaccharide. Exemplary proteins include, but are not limited to, dairy proteins, whey proteins, caseins and fractions thereof, gelatin, corn zein protein, bovine serum albumin, egg albumin, grain protein extracts (e.g. protein from wheat, barley, rye, oats, etc.) vegetable proteins, microbial proteins, legume proteins, proteins from tree nuts, and proteins from ground nuts. Exemplary polysaccharides include but are not limited to pectin, carrageenan, alginate, xanthan gum, modified celluloses (e.g., carboxymethylcellulose) gum acacia, gum ghatti, gum karaya, gum tragacanth, locust bean gum, guar gum, psyllium seed gum, quince seed gum, larch gum (e.g., arabinogalactans), stractan gum, agar, furcellaran, modified starches, gellan gum, and fucoidan.

In certain exemplary embodiments, the amount of the at least one microencapsulated citrus phytochemical is greater than about 1 mg per 8 oz serving of the beverage (e.g., from about 125 mg to about 2000 mg per 8 oz serving, from about 500 mg to about 1000 mg per 8 oz serving, from about 300 mg to about 700 mg per 8 oz serving, from about 125 mg to about 500 mg per 8 oz serving, from about 60 mg to about 90 mg per 8 oz serving). In certain exemplary embodiments, the amount of microencapsulated citrus limonoid is at least about 1 mg per 8 oz serving of the beverage (e.g., from about 2 mg to about 200 mg per 8 oz serving, from about 10 mg to about 100 mg per 8 oz serving). In certain exemplary embodiments, the amount of microencapsulated citrus flavonoid is from about 125 mg to about 2000 mg per 8 oz serving of the beverage (e.g., from about 500 mg to about 100 mg per 8 oz serving, from about 300 mg to about 700 mg per 8 oz serving).

It should be understood that beverages in accordance with this disclosure may have any of numerous different specific formulations or constitutions. The formulation of a beverage in accordance with this disclosure can vary to a certain extent, depending upon such factors as the beverage's intended market segment, its desired nutritional characteristics, flavor profile and the like. For example, it will generally be an option to add further beverage ingredients to the formulation of a particular beverage embodiment, including any of the beverage formulations described herein. Other additional beverage ingredients are also contemplated and within the scope of the invention.

The beverages disclosed herein include ready-to-drink liquid formulations. The present invention also relates to beverage concentrates used to prepare the beverage described herein. As used herein, the term “beverage concentrate” refers to a concentrate that is in the form of a liquid, gel, or an essentially dry mixture. The essentially dry mixture is typically in the form of a powder, although it may also be in the form of a single-serving tablet, or any other convenient form. The concentrate is formulated to provide a full strength beverage as described herein when reconstituted or diluted with a diluent, preferably water. In certain other embodiments, a full strength beverage is directly prepared without the formation of a concentrate and subsequent dilution. Sports drinks may be in ready-to-drink form or may be beverage concentrates (e.g., liquids, powders, or tablets) that are reconstituted with a diluent, preferably water, to form a full strength beverage.

In certain exemplary embodiments, the beverage may further comprise at least one additional beverage ingredient (e.g., water, carbonation, a sweetener, an acidulant, a flavorant, a colorant, a vitamin, a mineral, a preservative, an emulsifier, a thickening agent, a clouding agent, and mixtures of any of them). Other ingredients are also contemplated. The additional beverage ingredients may be added at various points during beverage production, including before or after addition of the microencapsulated citrus phytochemical composition.

Added water can be used in the manufacture of certain embodiments of the beverage, and water of a standard beverage quality can be employed in order not to adversely affect beverage taste, odor, or appearance. The water typically will be clear, colorless, free from objectionable minerals, tastes and odors, free from organic matter, low in alkalinity and of acceptable microbiological quality based on industry and government standards applicable at the time of producing the beverage. In certain exemplary embodiments, added water is present at a level of from about 0% to about 95% by weight of the full strength beverage (e.g., from about 10% to about 90% by weight, from about 25% to about 85% by weight).

Carbonation may be used to provide effervescence to certain exemplary embodiments of the beverages disclosed herein. Any of the techniques and carbonating equipment known in the art for carbonating beverages, that is, dissolving carbon dioxide into beverages, can be employed. Carbonation can enhance the beverage taste and appearance and can aid in preserving the beverage by inhibiting the growth and/or destroying objectionable bacteria. In certain exemplary embodiments, the beverage has a carbon dioxide level up to about 7.0 volumes carbon dioxide, e.g., from about 0.5 to about 5.0 volumes of carbon dioxide. As used herein, one volume of carbon dioxide is defined as the amount of carbon dioxide absorbed by any given quantity of water at 60° F. (16° C.) and atmospheric pressure. The carbon dioxide content in the beverage can be selected by those skilled in the art based on the desired level of effervescence and the impact of the carbonation on the taste and mouthfeel of the beverage.

Certain exemplary embodiments of the beverages disclosed herein include at least one sweetener as an additional beverage ingredient. Sweeteners may be natural or artificial. Natural sweeteners include but are not limited to sucrose, fructose, glucose, maltose, rhamnose, tagatose, trehalose, corn syrups (e.g., high fructose corn syrup), fructo-oligosaccharides, invert sugar, maple syrup, maple sugar, honey, brown sugar, molasses, sorghum syrup, erythritol, sorbitol, mannitol, xylitol, glycyrrhizin, malitol, lactose, Lo Han Guo (“LHG”), rebaudiosides (e.g., rebaudioside A), stevioside, xylose, arabinose, isomalt, lactitol, maltitol, and ribose, thaumatin, monellin, brazzein, and monetin, and mixtures of any of them. In certain exemplary embodiments, the natural sweetener is a natural potent non-nutritive sweetener, for example rebaudioside A. Artificial sweeteners include but are not limited to aspartame, saccharin, sucralose, acesulfame potassium, alitame, cyclamate, neohesperidin dihydrochalcone, neotame, and mixtures of any of them. The amount of sweetener used in the beverage can be selected by those skilled in the art based on the sweetness intensity desired in the beverage.

In certain exemplary embodiments, the beverages disclosed here comprise an acidulant as an additional beverage ingredient. Acidulants lower the pH of the beverage and also provide tartness to the beverage. Acidulants include but are not limited to phosphoric acid, hydrochloric acid, citric acid, tartaric acid, malic acid, lactic acid, adipic acid, ascorbic acid, fumaric acid, gluconic acid, succinic acid, maleic acid, or mixtures of any of them. Certain exemplary embodiments comprise at least one acidulant used in an amount, collectively, of from about 0.01% to about 1.0% by weight of the beverage (e.g., from about 0.1% to about 0.75% by weight, from about 0.25% to about 0.5% by weight, from about 0.24% to about 0.45% by weight). In certain exemplary embodiments, beverages have a pH of from about 2.5 to about 4.5 (e.g., from about 2.75 to about 4.25, from about 2.9 to about 4.0). The amount of acidulant used in the beverage can be selected by those skilled in the art based on the acidulant used, the desired pH, other ingredients used, etc.

In certain exemplary embodiments, the beverages disclosed here comprise a flavorant as an additional beverage ingredient. Flavorants include fruit flavors, botanical flavors, and spice flavors, among others. Flavorants can be in the form of an extract, essential oil, oleoresin, juice concentrate, bottler's base, or other forms known in the art. Fruit flavors include, but are not limited to, flavors derived from orange, mandarin orange, blood orange, tangerine, clementine, grapefruit, lemon, rough lemon, lime, leech lime, tangelo, pummelo, pomelo, apple, grape, pear, peach, nectarine, apricot, plum, prune, pomegranate, blackberry, blueberry, raspberry, strawberry, cherry, cranberry, currant, gooseberry, boysenberry, huckleberry, mulberry, date, pineapple, banana, papaya, mango, lychee, passionfruit, coconut, guava, kiwi, watermelon, cantaloupe, honeydew melon, and combinations of any of them, for example fruit punch. However, fruit flavors when included do not provide the beverage of the present invention with a substantial percentage of fruit juice. In certain exemplary exemplary embodiments, the beverage comprises less than 10% fruit juice (e.g., less than 5% fruit juice, substantially no fruit juice. Botanical flavor refers to flavors derived from parts of a plant other than the fruit. As such, botanical flavors can include those flavors derived from essential oils and extracts of nuts, bark, roots and leaves. Examples of such flavors include cola flavor, tea flavor, coffee flavor, among others. Spice flavors include but are not limited to flavors derived from cassia, clove, cinnamon, pepper, ginger, vanilla, cardamom, coriander, root beer, sassafras, ginseng, and others. Numerous additional and alternative flavorings suitable for use in at least certain exemplary embodiments will be apparent to those skilled in the art given the benefit of this disclosure. In at least certain exemplary embodiments, such spice or other flavors compliment that of a fruit flavor. It will be within the ability of those skilled in the art, given the benefit of this disclosure, to select a suitable flavorant or combination of flavorants for beverages according to this disclosure. In general it has been found that a flavorant at a concentration of from about 0% to about 0.400% by weight (e.g., from about 0.050% to about 0.200%, from about 0.080 to about 0.150%, from about 0.090 to about 0.120% by weight). is useful in certain exemplary embodiments of the present invention.

In certain exemplary embodiments, the beverage of the present invention may also include a clouding agent at a concentration range of from about 0 to about 100 ppm (e.g., from about 10 to about 50 ppm, from about 15 to about 35 ppm). Examples of clouding agents include, but are not limited to, ester gum, SAIB, starch components and mixtures thereof.

In certain exemplary embodiments, the beverage products disclosed here comprise a vitamin and/or a mineral as an additional beverage ingredient. Examples of vitamins include, but are not limited to, Vitamins A, C (ascorbic acid), D, E (tocopherol/tocotrienol), B₁ (thiamine), B₂ (riboflavin), B₃ (niacin), B₅, B₆, B₇ (biotin), B₉ (folic acid), B₁₂, and K, and combinations of any of them. Examples of minerals include, but are not limited to, sodium, potassium, calcium, magnesium, chloride, and combinations of any of them. It will be within the ability of those skilled in the art, given the benefit of this disclosure, to select a suitable vitamin, mineral, or combination thereof for beverages according to this disclosure.

Preservatives may be used in at least certain embodiments of the beverages disclosed here. That is, at least certain exemplary embodiments contain an optional dissolved preservative system. Beverages with a pH below 4 and especially those below 3 typically are “microstable,” i.e., they resist growth of microorganisms, and so are suitable for longer term storage prior to consumption without the need for further preservatives. However, an additional preservative system can be used if desired. If a preservative system is used, it can be added to the beverage at any suitable time during production, e.g., in some cases prior to the addition of a sweetener. As used here, the terms “preservation system” or “preservatives” include all suitable preservatives approved for use in food and beverage compositions, including, without limitation, such known preservatives as nisin, cinnamic acid, sorbates, e.g., sodium, calcium, and potassium sorbate, benzoates, e.g., sodium and potassium sorbate, citrates, e.g., sodium citrate and potassium citrate, and antioxidants such as ascorbic acid. Preservatives can be used in amounts not exceeding mandated maximum levels under applicable laws and regulations. The level of preservative used typically is adjusted according to the planned final product pH, as well as an evaluation of the microbiological spoilage potential of the particular beverage formulation. The maximum level employed typically is about 0.05% by weight of the beverage. It will be within the ability of those skilled in the art, given the benefit of this disclosure, to select a suitable preservative or combination of preservatives for beverages according to this disclosure.

Other methods of beverage preservation suitable for at least certain exemplary embodiments of the beverages disclosed here include, e.g., heat treatment or thermal processing steps, such as hot filling and tunnel pasteurization. Such steps can be used to reduce yeast, mold and microbial growth in the beverage products. For example, U.S. Pat. No. 4,830,862 to Braun et al. discloses the use of pasteurization in the production of fruit juice beverages as well as the use of suitable preservatives in carbonated beverages. U.S. Pat. No. 4,925,686 to Kastin discloses a heat-pasteurized freezable fruit juice composition which contains sodium benzoate and potassium sorbate.

Certain aspects of the present invention are directed to methods for concealing the bitterness of citrus phytochemicals, and methods for preparing a beverage comprising microencapsulated citrus phytochemicals. In certain exemplary embodiments, a method is provided for concealing the bitterness of citrus phytochemicals comprising the steps of providing at least one citrus phytochemical and microencapsulating the citrus phytochemical. In certain exemplary embodiments, a method for preparing a beverage is provided comprising the steps of providing at least one citrus phytochemical composition comprising a citrus phytochemical which contributes at least 60% by weight (e.g., at least 70% by weight, at least 80% by weight, at least 90% by weight, at least 95% by weight, at least 98% by weight) of the total amount of citrus phytochemical in the citrus phytochemical composition, microencapsulating the citrus phytochemical composition, and mixing the microencapsulated citrus phytochemical composition with at least one hydration improving substance, water, and optionally at least one additional beverage ingredient. In certain exemplary embodiments, the beverage is a sports drink and/or an isotonic beverage. In certain exemplary embodiments, the hydration improving substance comprises at least one of an electrolyte, a carbohydrate, a betaine, and glycerol. In certain exemplary embodiments, the amount of the at least one microencapsulated citrus phytochemical is greater than about 1 mg per 8 oz serving of the beverage (e.g., from about 125 mg to about 2000 mg per 8 oz serving, from about 500 mg to about 1000 mg per 8 oz serving, from about 300 mg to about 700 mg per 8 oz serving, from about 125 mg to about 500 mg per 8 oz serving, from about 60 to about 90 mg per 8 oz serving).

In certain exemplary embodiments, a method for preparing a beverage is provided comprising the steps of providing at least one microencapsulated citrus phytochemical composition comprising a citrus phytochemical which contributes at least 60% by weight (e.g., at least 70% by weight, at least 80% by weight, at least 90% by weight, at least 95% by weight, at least 98% by weight) of the total amount of citrus phytochemicals in the microencapsulated citrus phytochemical composition, and mixing the microencapsulated citrus phytochemical with at least one hydration improving substance, water, and optionally at least one additional beverage ingredient. In certain exemplary embodiments, the beverage is a sports drink and/or an isotonic beverage. In certain exemplary embodiments, the hydration improving substance comprises at least one of an electrolyte, a carbohydrate, a betaine, and glycerol. In certain exemplary embodiments, the amount of the at least one microencapsulated citrus phytochemical is greater than about 1 mg per 8 oz serving of the beverage (e.g., from about 125 mg to about 2000 mg per 8 oz serving, from about 500 mg to about 1000 mg per 8 oz serving, from about 300 mg to about 700 mg per 8 oz serving, from about 125 mg to about 500 mg per 8 oz serving, from about 60 mg to about 90 mg per 8 oz serving).

Non-limiting exemplary methods for the step of microencapsulating the citrus phytochemicals include chemical and physical microencapsulation methods. Chemical microencapsulation methods include, but are not limited to, e.g., simple or complex coacervation, solvent evaporation, polymer-polymer incompatibility, matrix polymerization, in-liquid drying, and desolvation in liquid media. Physical microencapsulation methods include, but are not limited to, e.g., spray drying processes, vibration nozzle, centrifugal extrusion, pressure extrusion, hot melt processes, fluidized bed, air suspension cooling, electrostatic deposition, rotational suspension separation, and spraying solvent extraction bath. In certain exemplary embodiments, microencapsulating the citrus phytochemical comprises a step selected from complex coacervation, spray drying, and centrifugal extrusion.

As used herein, the step of “microencapsulating” includes core-shell microencapsulation, producing particles having a core of one or more citrus phytochemicals dissolved or dispersed in an oil-miscible solvent (e.g., medium chain triglycerides, limonene, benzyl alcohol, etc.) and a shell of encapsulant material. Core-shell encapsulation may also include particles having multiple cores and/or multiple shells and/or agglomerated core-shell particles. Core-shell microcapsules can be produced by a variety of means including, for example, solvent evaporation, spinning disk, electro-hydrodynamic spraying, spray drying, fluidized bed coating, etc. As used herein, the step of “microencapsulating” may also include encapsulation of citrus phytochemicals in coacervates (e.g., complex coacervates), liposomes (e.g., using lecithin as the encapsulant), nano-porous structures (e.g., inside cellulose particles, silica particles, kaolin, cyclodextrins), liquid crystalline structures (e.g., using phospholipids, monoglycerides), natural encapsulants (e.g., inside yeast, fungal spores, pollen), or inclusion particles (e.g., within particles of gelling polymer, comminuted fruit pieces).

In core-shell encapsulation, the core may also include a gel in addition to the citrus phytochemical, for example, calcium alginate or heat-treated whey protein. The shell may be composed of a wide variety of substances, for example, waxes, fats, shellac, protein (e.g., whey, zein, gelatin, soy, etc.), and/or a hydrocolloid (e.g., starch or modified starch, cellulosics, xanthan, gellan, pectin, etc.). The shell may be designed to respond to a particular physiological or environmental condition to expose the core, thus releasing the micro encapsulated citrus phytochemical by diffusion or other means (e.g., acid hydrolysis, enzymatic action, osmotic pressure, concentration gradients, etc.). Core-shell microcapsules can be produced by a variety of means including, for example, solvent evaporation, spinning disk, electro-hydrodynamic spraying, spray drying, fluidized bed coating, etc. Zein protein from corn is a specific example of a shell which can form around an oil-soluble core merely by dilution of the solvent (aqueous alcohol solution) by water. In this manner, a concentrated solution of zein in aqueous alcohol which also contains the encapsulate substance (in this case a citrus phytochemical) forms microcapsules by combining physical agitation (high shear or homogenization), with simultaneous dilution with water.

Coacervates (e.g., complex coacervates) have a shell comprised of two polymers having opposite net charges from each other at the pH of the finished product, e.g., pH 3.2. To produce coacervates, the core material (e.g., a citrus phytochemical dissolved or dispersed in an oil-miscible solvent (e.g., medium chain triglycerides, limonene, benzyl alcohol, etc.)) is surrounded by the first polymer, typically via homogenization or high shear mixing of an oil-soluble substance with a solution of protein (e.g., whey), followed by addition of a second solution of a hydrocolloid (e.g., pectin). The pH is then lowered to the product target pH whereby the protein exhibits a net positive charge and the hydrocolloid exhibits a net negative charge, which by mutual attraction, leads to a polymer complex “shell” around the core called a coacervate. Coacervates may also include “layer-by layer” shell development, whereby layers of positively and negatively charged polymers are alternately added to form thicker and more protective barriers.

Liposomes may comprise an encapsulant that lowers interfacial tension, for example lecithin or components of lecithin (e.g., phospholipids and lyso-phosopholipids), which surrounds a core substance (e.g., a citrus phytochemical dissolved or dispersed in an oil-miscible solvent (e.g., medium chain triglycerides, limonene, benzyl alcohol, etc.)). Liposomes may be formed by the addition of external energy (e.g., homogenization, ultrasonic treatment, or other equivalent energy input mechanisms). Liposomes can be unilamellar or multilamellar, depending on the precise formula and processing parameters. For beverage applications, liposomes preferentially encapsulate oil-soluble components like citrus phytochemicals, as opposed to water-soluble components. Liposome surfaces can be modified by covalent or noncovalent addition of ligands which confer specific binding capabilities to the structure, thus aiding in targeting of the encapsulated substance. Typical surface modifications include addition of an antibody to a cell surface antigen, which dramatically increases the likelihood of the encapsulated substance reaching specific cells (e.g., oral mucosal cells, stomach, or intestinal mucosal cells for beverage and food applications).

Double encapsulation is a combination of some of the technologies described above. An example would be a capsule containing many smaller capsules, with the outer most shell designed to dissolve or disintegrate upon the appropriate stimulus, e.g., wetting in saliva, amylase enzyme activity, mastication (shear), neutral pH, etc. This approach allows multiple encapsulated compounds to be delivered sequentially, assuming the outer most shell and the surface of the inner capsules are triggered either by different mechanisms, or follow each other based on diffusion kinetics timing. Another form of double encapsulation is multiphasic in that it can be an oil-in-water-in-oil double “emulsion,” or a water-in-oil-in-water double “emulsion”; the latter being most appropriate for beverage applications where the beverage is the outer most water phase. Double emulsions are constructed inside-out starting with the inner most “emulsion”. This requires use of at least two surfactants having widely different HLB values to act at the appropriate interfaces (oil/water as compared to water/oil). As a result, encapsulated substances having either water-solubility or oil-solubility can be encapsulated simultaneously or separately.

Nano-porous particles that naturally contain nano-pores, or are deliberately constructed to contain uniform nano-porous cavities can encapsulate a variety of oil-soluble substances (e.g., a citrus phytochemical dissolved or dispersed in an oil-miscible solvent (e.g., medium chain triglycerides, limonene, benzyl alcohol, etc.)) by a combination of capillary action and interfacial attraction. Release is governed by simple diffusion or may require physical shear, pH change, or enzymatic action. Examples of nano-porous encapsulants include cellulose particles, silica particles, or natural clay (Kaolin). On a more molecular level, cyclodextrins could be considered nano-porous materials, in that they encapsulate substances that “fit” the cavity of the ringed cyclodextrin structure, depending upon both the hydrodynamic size of the encapsulated substance, and the size of the ring (there are several different cyclodextrins available).

Sub-micron liquid crystalline structures having a continuous structured phase and a network of nano-pores can be fabricated from edible materials like phospholipids and monoglycerides, when processed at the correct ratio of surfactant, encapsulated substance (e.g., a citrus phytochemical dissolved or dispersed in an oil-miscible solvent (e.g., medium chain triglycerides, limonene, benzyl alcohol, etc.)), and oil/water phase. These liquid crystalline materials are not solid particles but act more like gels or concentrated polymer solutions, yet absorb and release encapsulated substances much like nano-porous particles described above. Though most traditional structures of this definition are too viscous to be considered for beverage applications, broken or fractional liquid crystals have been found to possess equivalent encapsulation properties, but do not have an infinitely extended structure and consequently have lower viscosities.

Natural capsules, like yeast, fungal spores, and pollen, can also encapsulate oil-soluble substances (e.g., a citrus phytochemical dissolved or dispersed in an oil-miscible solvent (e.g., medium chain triglycerides, limonene, benzyl alcohol, etc.)). Each of these natural encapsulants offers different opportunities for protection and release, depending upon the chemical nature of the encapsulated substance and the finished product matrix.

Inclusion particles comprise micron-scale particles prepared by gelling a polymer with an oil-soluble substance (e.g., a citrus phytochemical dissolved or dispersed in an oil-miscible solvent (e.g., medium chain triglycerides, limonene, benzyl alcohol, etc.)) in its matrix during polymerization, e.g., gelling of sodium alginate upon addition of calcium. By this means, oil-soluble substances are entrapped in an aqueous gel until the gel is broken by physical, environmental, or metabolic means.

As used herein, the step of “microencapsulating” produces particles having an average particle size in the micron/micrometer/μm range. In certain exemplary embodiments, the step of microencapsulating citrus phytochemicals produces an average particle size in the range of about 1 to about 500 microns (e.g., 5 to 300 microns, 10 to 200 microns, 20 to 150 microns, 50 to 100 microns, 10 to 50 microns). In certain exemplary embodiments, the step of microencapsulating citrus phytochemicals produce an average particle size in the range of about 0.05 microns to 20 microns (e.g., 0.1 to 10 microns, 0.5 to 2.0 microns). In certain exemplary embodiments, the step of microencapsulating citrus phytochemicals produces an average particle size of less than 1.0 micron (e.g., 0.05 to 0.9 microns, 0.1 to 0.5 microns). In view of this disclosure, the skilled artisan will be able to vary the particle size as necessary to be optimally included in a particular beverage product. Particle size may be selected based on the desired mouthfeel, visual appearance (e.g., clear, hazy, cloudy, or opaque), oxidation stability, and suspension stability within the beverage.

In certain exemplary embodiments, the step of microencapsulating the citrus phytochemical uses an encapsulant comprising at least one of a protein and a polysaccharide. Exemplary proteins include, but are not limited to, dairy proteins, whey proteins, caseins and fractions thereof, gelatin, corn zein protein, bovine serum albumin, egg albumin, grain protein extracts (e.g. protein from wheat, barley, rye, oats, etc.) vegetable proteins, microbial proteins, legume proteins, proteins from tree nuts, and proteins from ground nuts. Exemplary polysaccharides include but are not limited to pectin, carrageenan, alginate, xanthan gum, modified celluloses (e.g., carboxymethylcellulose) gum acacia, gum ghatti, gum karaya, gum tragacanth, locust bean gum, guar gum, psyllium seed gum, quince seed gum, larch gum (e.g., arabinogalactans), stractan gum, agar, furcellaran, modified starches, gellan gum, and fucoidan.

In certain exemplary embodiments of the methods disclosed herein, the citrus phytochemical may be derived from at least one of orange, mandarin orange, blood orange, tangerine, clementine, grapefruit, lemon, rough lemon, lime, leech lime, tangelo, pummelo, and pomelo, among other citrus fruits. In certain exemplary embodiments of the methods disclosed herein, the citrus phytochemical comprises at least one of a citrus flavonoid (e.g., hesperetin, hesperidin, neohesperidin, quercetin, quercitrin, rutin, narirutin, nobiletin, tangeritin, naringin, naringenin, poncirin, scutellarein, sinensetin) and a citrus limonoid (e.g., limonin, obacunone, nomilin, glycoside derivatives of any of them), and optionally a tocopherol. In certain exemplary embodiments of the methods disclosed herein, the citrus juice may be derived from at least one of orange, mandarin orange, blood orange, tangerine, clementine, grapefruit, lemon, rough lemon, lime, leech lime, tangelo, pomelo, pummelo, and any other citrus fruit. Certain exemplary embodiments of the methods disclosed herein further comprise the step of mixing in an additional beverage ingredient comprises at least one of carbonation, a sweetener, an acidulant, a flavorant, a colorant, a vitamin, a mineral, a preservative, an emulsifier, a thickening agent, a clouding agent, and a combination of any of them.

The following examples are specific embodiments of the present invention but are not intended to limit it.

### EXAMPLES

Four sports drink samples according to the present invention are prepared by mixing together the ingredients in the amounts shown in each of the columns below:

| | Sample 1 | Sample 2 | Sample 3 | Sample 4 |
|---|---|---|---|---|
| Ingredients | Weight % | Weight % | Weight % | Weight % |
| Water | 94.808% | 89.010% | 86.812% | 84.614% |
| Sucrose Syrup | 2.000% | 5.000% | 6.000% | 7.000% |
| High Fructose Corn | 1.600% | 4.000% | 4.800% | 5.600% |
| Syrup | | | | |
| Sodium Chloride | 0.048% | 0.060% | 0.072% | 0.084% |
| Sodium Citrate | 0.048% | 0.060% | 0.072% | 0.084% |
| Monopotassium | 0.032% | 0.040% | 0.048% | 0.056% |
| Phosphate | | | | |
| Food Acids | 0.240% | 0.300% | 0.360% | 0.420% |
| Flavors | 0.800% | 1.000% | 1.200% | 1.400% |
| Microencapsulated Citrus | 0.400% | 0.500% | 0.600% | 0.700% |
| Phytochemical | | | | |
| Composition | | | | |
| Ester Gums | 0.012% | 0.015% | 0.018% | 0.021% |
| Food Colors | 0.004% | 0.005% | 0.006% | 0.007% |
| Food Oils | 0.008% | 0.010% | 0.012% | 0.014% |
| Total | 100.000% | 100.000% | 100.000% | 100.000% |

Given the benefit of the above disclosure and description of exemplary embodiments, it will be apparent to those skilled in the art that numerous alternative and different embodiments are possible in keeping with the general principles of the invention disclosed here. Those skilled in this art will recognize that all such various modifications and alternative embodiments are within the true scope and spirit of the invention. The appended claims are intended to cover all such modifications and alternative embodiments. It should be understood that the use of a singular indefinite or definite article (e.g., “a,” “an,” “the,” etc.) in this disclosure and in the following claims follows the traditional approach in patents of meaning “at least one” unless in a particular instance it is clear from context that the term is intended in that particular instance to mean specifically one and only one. Likewise, the term “comprising” is open ended, not excluding additional items, features, components, etc.

What is claimed is:

1. A beverage comprising:
water;
at least one hydration improving substance; and
at least one microencapsulated citrus phytochemical composition comprising a citrus phytochemical which contributes at least 60% by weight of the total amount of citrus phytochemical in the microencapsulated citrus phytochemical composition.

2. The beverage of claim 1, wherein the hydration improving substance comprises at least one of an electrolyte, a carbohydrate, a betaine, and glycerol.

3. The beverage of claim 2, wherein the hydration improving substance comprises at least one of sodium, potassium, magnesium, calcium, and chloride.

4. The beverage of claim 2, wherein the hydration improving substance comprises at least one of sucrose, maltose, maltodextrin, glucose, galactose, trehalose, fructose, fructo-oligosaccharides, beta-glucan, and trioses.

5. The beverage of claim 2, wherein the hydration improving substance comprises trimethylglycine.

6. The beverage of claim 1, wherein the beverage has an osmolality in the range of 220 mOsm/kg to 350 mOsm/kg of the beverage.

7. The beverage of claim 1, wherein the beverage has an osmolality in the range of 230 mOsm/kg to 320 mOsm/kg of the beverage.

8. The beverage of claim 1, wherein the beverage has an osmolality in the range of 250 mOsm/kg to 270 mOsm/kg of the beverage.

9. The beverage of claim 1, wherein the beverage is at least one of a sports drink, an isotonic beverage, a hypertonic beverage, and a hypotonic beverage.

10. The beverage of claim 1, wherein the citrus phytochemical contributes at least 80% by weight of the total amount of citrus phytochemical in the microencapsulated citrus phytochemical composition.

11. The beverage of claim 1, wherein the citrus phytochemical contributes at least 95% by weight of the total amount of citrus phytochemical in the microencapsulated citrus phytochemical composition.

12. The beverage of claim 1, wherein the amount of microencapsulated citrus phytochemical is from 125 mg to 2000 mg per 8 oz serving of the beverage.

13. The beverage of claim 1, wherein the amount of microencapsulated citrus phytochemical is from 500 mg to 1000 mg per 8 oz serving of the beverage.

14. The beverage of claim 1, wherein the amount of microencapsulated citrus phytochemical is from 125 mg to 500 mg per 8 oz serving of the beverage.

15. The beverage of claim 1, wherein the microencapsulated citrus phytochemical composition comprises at least one of a citrus flavonoid and a citrus limonoid.

16. The beverage of claim 15, wherein the microencapsulated citrus phytochemical composition comprises a citrus flavonoid and a citrus limonoid, wherein the citrus flavonoid and the citrus limonoid are microencapsulated separately in separate particles.

17. The beverage of claim 15, wherein the microencapsulated citrus phytochemical composition comprises a citrus flavonoid and a citrus limonoid, wherein the citrus flavonoid and the citrus limonoid are microencapsulated together in the same particle.

18. The beverage of claim 15, wherein the microencapsulated citrus phytochemical composition further comprises a tocopherol microencapsulated together in the same particle.

19. The beverage of claim 15, wherein the citrus flavonoid comprises at least one of hesperidin, hesperetin, neohesperidin, naringin, naringenin, quercetin, quercitrin, rutin, tangeritin, narirutin, nobiletin, poncirin, scutellarein, and sinensetin.

20. The beverage of claim 15, wherein the citrus limonoid comprises at least one of limonin, obacunone, nomilin, and glycoside derivatives of any of them.

21. The beverage of claim 1, wherein the microencapsulated citrus phytochemical is derived from at least one of orange, mandarin orange, blood orange, tangerine, clementine, grapefruit, lemon, rough lemon, lime, leech lime, tangelo, pummelo, and pomelo.

22. The beverage of claim 1, wherein the bioavailablity of the at least one microencapsulated citrus phytochemical is greater than the bioavailability of the same amount of that citrus phytochemical unencapsulated in a beverage.

23. The beverage of claim 1, wherein the microencapsulated citrus phytochemical comprises an encapsulant comprising at least one of a protein and a polysaccharide.

24. The beverage of claim 23, wherein the protein comprises at least one of dairy proteins, whey proteins, caseins and fractions thereof, gelatin, corn zein protein, bovine serum albumin, egg albumin, grain protein extracts, wheat protein, barley protein, rye protein, oat protein, vegetable proteins, microbial proteins, legume proteins, proteins from tree nuts, and proteins from ground nuts.

25. The beverage of claim 23, wherein the polysaccharide comprises at least one of pectin, carrageenan, alginate, xanthan gum, modified celluloses, carboxymethylcellulose, chitosan, gum acacia, gum ghatti, gum karaya, gum tragacanth, locust bean gum, guar gum, psyllium seed gum, quince seed gum, larch gum, arabinogalactans, stractan gum, agar, furcellaran, modified starches, gellan gum, and fucoidan.

26. The beverage of claim 1, wherein the microencapsulated citrus phytochemical is produced by at least one of core-shell encapsulation, complex coacervation, liposome formation, double encapsulation, centrifugal extrusion, and spray drying.

27. The beverage of claim 1, wherein the encapsulated citrus phytochemical has an average particle size in the range of 1 micron to 500 microns.

28. The beverage of claim 1, wherein the encapsulated citrus phytochemical has an average particle size in the range of 10 micron to 200 microns.

29. The beverage of claim 1, further comprising at least one additional beverage ingredient selected from the group consisting of carbonation, a sweetener, a flavorant, an acidulant, a colorant, a vitamin, a mineral, an anti-oxidant, a preservative, an emulsifier, a thickening agent, a clouding agent, and combinations of any of them.

30. The beverage of claim 29, wherein the flavorant comprises a fruit flavor selected from the group consisting of orange, mandarin orange, blood orange, tangerine, clementine, grapefruit, lemon, rough lemon, lime, leech lime, tangelo, pummelo, pomelo, apple, grape, pear, peach, nectarine, apricot, plum, prune, pomegranate, blackberry, blueberry, raspberry, strawberry, cherry, cranberry, currant, gooseberry, boysenberry, huckleberry, mulberry, date, pineapple, banana, papaya, mango, lychee, passionfruit, coconut, guava, kiwi, watermelon, cantaloupe, honeydew melon, and combinations of any of them.

31. The beverage of claim 29, wherein the acidulant selected from the group consisting of citric acid, ascorbic acid, malic acid, lactic acid, tartaric acid, cinnamic acid, fumaric acid, maleic acid, adipic acid, glutaric acid, succinic acid, and combinations of any of them.

32. The beverage of claim 1, comprising substantially no fruit juice.

33. A beverage concentrate comprising:
at least one hydration improving substance; and
at least one microencapsulated citrus phytochemical composition comprising a citrus phytochemical which contributes at least 60% by weight of the total amount of citrus phytochemical in the microencapsulated citrus phytochemical composition;
wherein the beverage concentrate when diluted with water produces a beverage which is a sports drink.

34. A method for preparing a beverage comprising the steps of:
providing at least one citrus phytochemical composition comprising a citrus phytochemical which contributes at least 60% by weight of the total amount of citrus phytochemical in the citrus phytochemical composition,
microencapsulating the citrus phytochemical composition, and
mixing the microencapsulated citrus phytochemical composition with at least one hydration improving substance, water, and optionally at least one additional beverage ingredient.

35. The beverage of claim 34, wherein the hydration improving substance comprises at least one of an electrolyte, a carbohydrate, a betaine, and glycerol.

36. The method of claim 34, wherein microencapsulating the citrus phytochemical comprises at least one of core-shell encapsulation, complex coacervation, liposome formation, double encapsulation, spray-drying, and centrifugal extrusion.

37. A method for making a beverage comprising the steps of:
providing at least one microencapsulated citrus phytochemical composition comprising a citrus phytochemical which contributes at least 60% by weight of the total amount of citrus phytochemical in the microencapsulated citrus phytochemical composition; and
mixing the microencapsulated citrus phytochemical composition with at least one hydration improving substance, water, and optionally at least one additional beverage ingredient.

38. The beverage of claim 37, wherein the hydration improving substance comprises at least one of an electrolyte, a carbohydrate, a betaine, and glycerol.
